(19) United States
(12) Patent Application Publication
(10) Pub. No.: US 2026/0058358 A1
(43) Pub. Date: Feb. 26, 2026

(54) ELECTRONIC SYSTEM COMPRISING A RADAR ANTENNA AND EMISSION DEVICE

(71) Applicant: ams-OSRAM International GmbH, Regensburg (DE)

(72) Inventors: Georg ROSSBACH, Wenzenbach (DE); Christian SCHOERNER, Regensburg (DE); Erwin LANG, Regensburg (DE)

(21) Appl. No.: 19/120,344

(22) PCT Filed: Oct. 12, 2023
(86) PCT No.: PCT/EP2023/078371

§ 371 Date: Apr. 11, 2025

(30) Foreign Application Priority Data
Oct. 12, 2022 (DE) 10 2022 126 476.9

(51) Int. Cl. H01Q 1/42; H01Q 1/44; H10F 39/90; H10F 77/00; H10F 77/30; H10H 20/84; H10H 20/857; H10H 29/20

(52) U.S. Cl. CPC H01Q 1/425; H01Q 1/44; H10F 39/90; H10F 77/306; H10F 77/933; H10H 20/84; H10H 20/857; H10H 29/20

(57) ABSTRACT

An electronic system includes a radar antenna, configured to emit electromagnetic radiation having a wavelength λ in a first direction. The electronic system also includes an electric device. The electric device is arranged in an emission direction of the radar antenna. The electric device includes a dielectric layer and a metal wiring for contacting elements of the electric device. A thickness of the dielectric layer measured in the first direction is determined so that the emitted electromagnetic radiation forms at least one standing wave having at least one minimum of electric field intensity within the dielectric layer. The metal wiring is arranged in a horizontal layer of the dielectric layer. A position, in the first direction, of the metal wiring is determined so that it corresponds to a minimum of the electric field strength of electromagnetic radiation having the wavelength λ.

Radar modules are increasingly being employed e.g. in automotive applications. Generally, concepts are being developed according to which the radar module may at the same time be a lighting module or wherein the radar module is integrated in a lighting module. For example, radar modules are developed in which the cover plate of the radar module may be in the form of a logo and may be lighting. For example, different segments of the cover plate may be controlled individually.

It is an object of the present invention to provide an improved electronic system. Moreover, it is an object to provide an improved emission device.

According to embodiments, the above object is achieved by the claimed matter according to the independent claims. Further developments are defined in the dependent claims.

According to embodiments, an electronic system comprises a radar antenna, configured to emit electromagnetic radiation having a wavelength 2, and an electric device. The electric device is arranged in an emission direction of the radar antenna. The electric device comprises a dielectric layer and a metal wiring for contacting elements of the electric device. A thickness d of the dielectric layer measured in a vertical direction is determined so that the emitted electromagnetic radiation forms at least one standing wave having at least one minimum of electric field intensity within the dielectric layer.

The metal wiring is arranged in a horizontal layer of the dielectric layer, and a vertical position of the metal wiring is determined so that it corresponds to a minimum of the electric field strength of electromagnetic radiation having the wavelength λ. For example, the electromagnetic radiation is transmitted through the dielectric layer in the vertical direction.

Due to this configuration, interaction of the emitted electromagnetic radiation and the metal wiring may be reduced.

For example, the thickness d of the dielectric layer may be determined so that:

$$d = λ * m / ( n * 2 ) ,$$

wherein m denotes an integer with m>0, and n denotes a refractive index of the dielectric layer. For example, this equation may hold, when the dielectric layer comprises a single layer only. According to further implementations, the dielectric layer may comprise several dielectric layers forming a dielectric layer stack. In this case, a thickness of the dielectric layer stack that enables the formation of standing waves may be determined e.g. by simulations.

The feature that a thickness d of the dielectric layer measured in a vertical direction is determined so that the emitted electromagnetic radiation forms at least one standing wave having at least one minimum of electric field intensity within the dielectric layer may mean that in the above formula m>0. As is defined, the at least one standing wave has at least one minimum of electric field intensity within the dielectric layer. In other words, it is intended that the at least one minimum is not positioned at an interface to an adjacent element outside the dielectric layer (stack) but inside the dielectric layer (stack). The term “minimum of electric field intensity” may also mean a position of destructive interference.

For example, the metal wiring comprises a metal mesh. The metal mesh may have a thickness of 30 nm to 100 μm, for example, 0.2 μm to 10 μm, or e.g. 1 to 3 μm.

A width of the individual metal wires forming the metal mesh may be 1 to 100 μm, for example 8 to 25 μm.

According to embodiments, a period of the metal mesh is smaller than z/n or even smaller than 0.5*λ/n. Further, the period of the metal mesh may be larger than 0.1*λ/n. Thereby, the transmission of the emitted electromagnetic radiation may be increased. The mesh does not need to consist of a periodic arrangement of single wires. When the distances between adjacent wires vary, the term “period” refers to an average distance between adjacent wires or to a mode of the distances between adjacent wires.

According to embodiments, the electric device comprises an optoelectronic semiconductor device. The optoelectronic semiconductor device comprises a first semiconductor layer of a first conductivity type, a second semiconductor layer of a second conductivity type, and an active zone for generating or absorbing electromagnetic radiation. The active zone is arranged between the first semiconductor layer and the second semiconductor layer.

For example, the metal mesh is electrically connected to the first or the second semiconductor layer. In more detail, the first or the second semiconductor layer may be electrically connected to a voltage terminal by means of the metal mesh. For example, a first part of the metal mesh may be connected to the first semiconductor layer, and a second part of the metal mesh may be connected to the second semiconductor layer. The first semiconductor layer may be electrically connected to a first voltage terminal via the first part of the metal mesh. The second semiconductor layer may be electrically connected to the second voltage terminal via the second part of the metal mesh.

According to implementations, the dielectric layer may comprise a first dielectric layer and a second dielectric layer, and the metal layer is arranged between the first dielectric layer and the second dielectric layer.

For example, at least one of the first and the second dielectric layers may comprise a multilayer stack. For example, the first and/or the second dielectric layer may comprise multiple layers that may be made of at least two different materials.

According to embodiments, the vertical position v of the metal wiring may be determined as v=λ*(k+0.5)/(2*n), wherein k<m. For example, in a case of a single dielectric layer the vertical position v may be determined in this way. According to further implementations, in particular, when the dielectric layer comprises several dielectric layers forming a dielectric layer stack, the vertical position of the metal wiring may be determined by wave-optical simulations to minimize the electromagnetic interaction between the metal wiring and the electromagnetic radiation.

According to further embodiments, an emission device comprises a radar antenna, configured to emit electromagnetic radiation having a wavelength λ, a dielectric layer that is arranged in an emission direction of the radar antenna, and a metal layer having a thickness of less than 500 nm. A thickness d of the dielectric layer measured in a vertical direction is determined so that the electromagnetic radiation forms at least one standing wave having at least one minimum of electric field intensity within the dielectric layer. The metal layer is arranged in a horizontal layer of the dielectric layer, and a vertical position of the metal layer is determined so that it corresponds to a minimum of the electric field strength of electromagnetic radiation having the wavelength λ.

For example, a thickness of the metal layer may be less than the skin depth of the metal layer, the skin depth being defined by the frequency of the electromagnetic radiation and the specific conductivity of the metal. Typically, the thickness of the metal layer may be less than a few 100 nm, e.g. less than 500 nm or less than 300 nm.

For example, the thickness d of the dielectric layer may be determined so that d=λ*m/(n*2), wherein m denotes an integer and n denotes a refractive index of the dielectric layer. This equation may be fulfilled when the dielectric layer comprises a single dielectric layer.

For example, the vertical position v of the metal layer is determined as v=λ*(k+0.5)/(2*n), wherein k<m. In a similar manner as has been discussed above, when the dielectric layer comprises several layers, the vertical position may be determined using simulations.

The accompanying drawings are included to provide a further understanding of embodiments of the invention and are incorporated in and constitute a part of this specification. The drawings illustrate the embodiments of the present invention and together with the description serve to explain the principles. Other embodiments of the invention and many of the intended advantages will be readily appreciated, as they become better understood by reference to the following detailed description. The elements of the drawings are not necessarily to scale relative to each other. Like reference numbers designate corresponding similar parts.

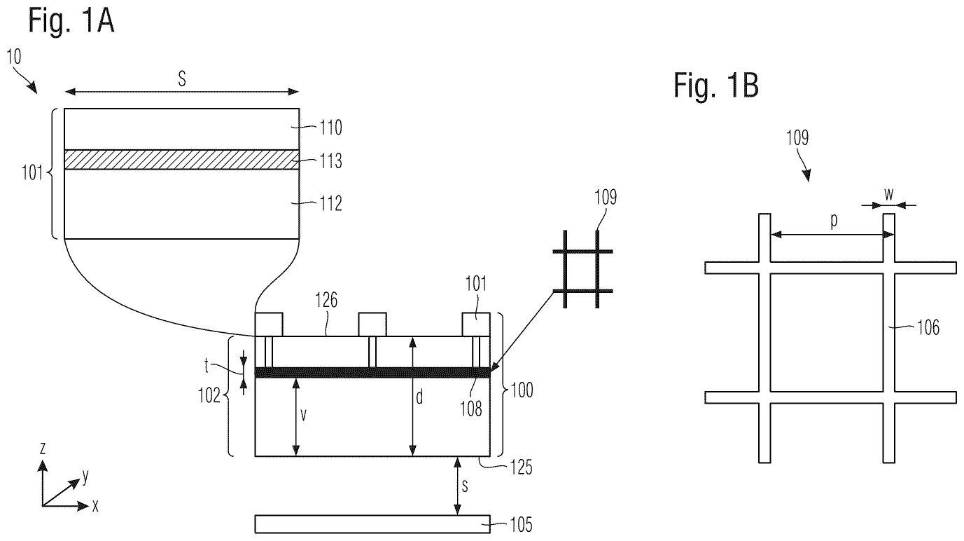

FIG. 1A shows a schematic view of an electronic system according to embodiments.

FIG. 1B shows elements of a metal wiring.

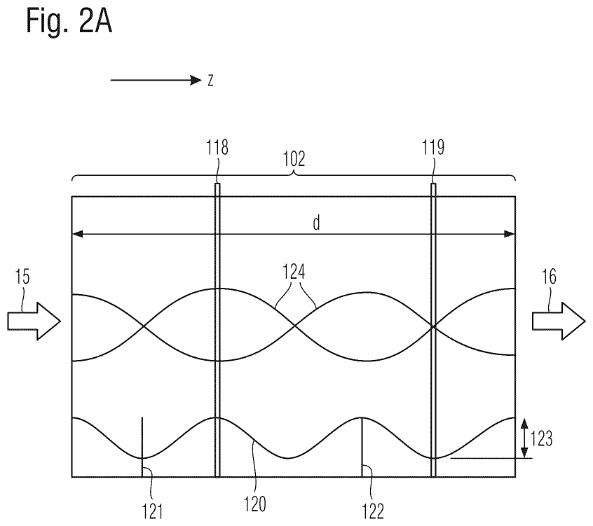

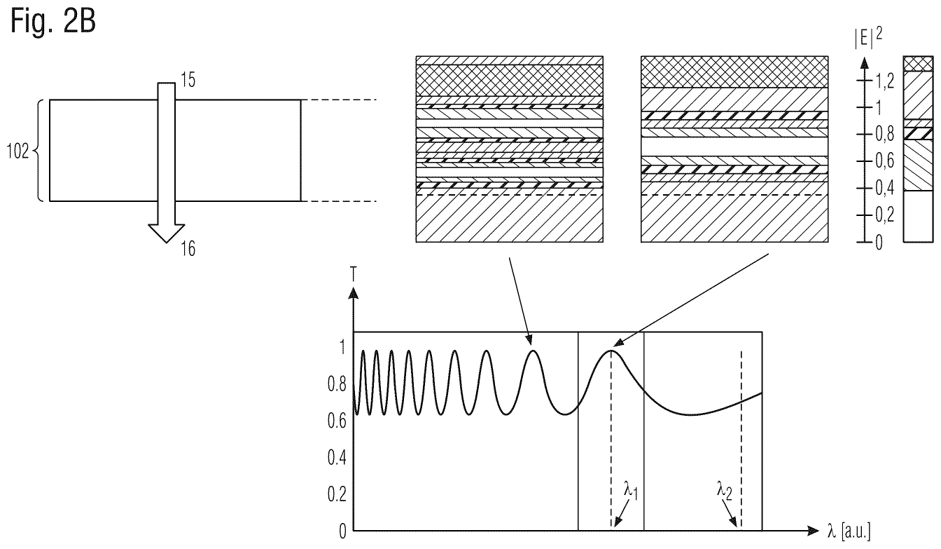

FIG. 2A illustrates a cross-sectional view of a dielectric layer.

FIG. 2B is a diagram for explaining details according to embodiments.

FIG. 2C is a schematic diagram for explaining effects of embodiments.

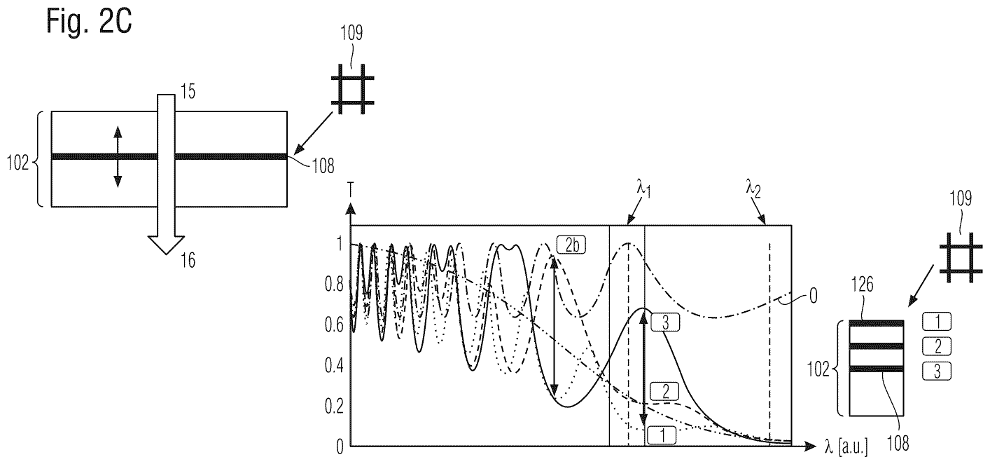

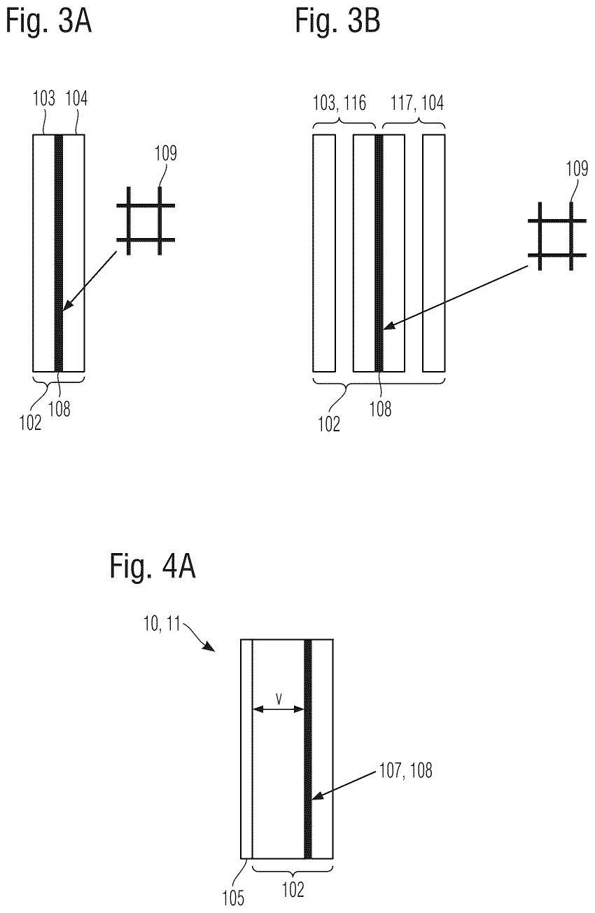

FIG. 3A shows a further example of a dielectric layer.

FIG. 3B further shows an example of a dielectric layer.

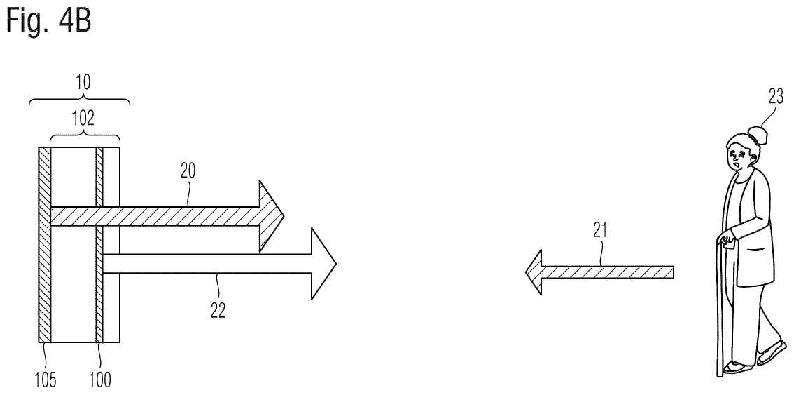

FIG. 4A shows a cross-sectional view of an electronic system or an emission device according to embodiments.

FIG. 4B shows an example of an electronic system.

In the following detailed description reference is made to the accompanying drawings, which form a part hereof and in which are illustrated by way of illustration specific embodiments in which the invention may be practiced. In this regard, directional terminology such as “top”, “bottom”, “front”, “back”, “over”, “on”, “above”, “leading”, “trailing” etc. is used with reference to the orientation of the Figures being described. Since components of embodiments of the invention can be positioned in a number of different orientations, the directional terminology is used for purposes of illustration and is in no way limiting. It is to be understood that other embodiments may be utilized and structural or logical changes may be made without departing from the scope defined by the claims.

The description of the embodiments is not limiting. In particular, elements of the embodiments described hereinafter may be combined with elements of different embodiments.

The terms “lateral” and “horizontal” as used in this specification intends to describe an orientation parallel to a first surface of a substrate or semiconductor body. This can be for instance the surface of a wafer or a die.

The term “vertical” as used in this specification intends to describe an orientation which is arranged perpendicular to the first surface of a substrate or semiconductor body.

The term “wavelength λ” is intended to specify the wavelength in vacuum, unless otherwise specified.

As employed in this specification, the terms “coupled” and/or “electrically coupled” are not meant to mean that the elements must be directly coupled together—intervening elements may be provided between the “coupled” or “electrically coupled” elements. The term “electrically connected” intends to describe a low-ohmic electric connection between the elements electrically connected together.

FIG. 1A shows a schematic view of an electronic system 10 according to embodiments. The electronic system 10 comprises a radar antenna 105 which is configured to emit electromagnetic radiation having a wavelength λ, and an electric device 100. The electric device 100 is arranged in an emission direction of the radar antenna. The electric device 100 comprises a dielectric layer 102 and a metal wiring 108 for contacting elements of the electric device 100. A thickness d of the dielectric layer 102 measured in a vertical direction, e.g. the z-direction, is determined so that the electromagnetic radiation emitted by the radar antenna forms at least one or more standing waves having at least one minimum of electric field intensity within the dielectric layer 102. For example, when the dielectric layer 102 comprises or consists of a single dielectric layer, the thickness may be determined as:

$$d = λ * m / ( n * 2 )$$

Wherein m denotes an integer with m>0 and n denotes a refractive index of the dielectric layer.

When the dielectric layer 102 comprises a plurality of dielectric layers, the thickness may be determined using e.g. simulation.

The metal wiring 108 is arranged in a horizontal layer of the dielectric layer 102. A vertical position v of the metal wiring is determined so that it corresponds to a minimum of the electric field strength of electromagnetic radiation having the wavelength λ.

For example, the radar antenna 105 may be a component of a generally known radar device. The radar antenna 105 may be configured to emit a typical wavelength of e.g. 3.9 mm or 12.5 mm. A distance s between the radar antenna 105 and the electric device 100 may be larger than an emission wavelength of the radar antenna 105. The dielectric material of the dielectric layer 102 may be a generally known dielectric material such as glass, PVB (polyvinyl butyral) or PET (polyethylene terephthalate). As is to be clearly understood, any other dielectric material may be employed. The dielectric material is transparent to the electromagnetic radiation emitted by the radar antenna. An explanation of the thickness d of the dielectric layer 102 will be given below with reference to FIG. 2A. The vertical position v corresponds to the distance v between the metal wiring 108 and a first main surface 125 of the dielectric layer 102. The first main surface 125 of the dielectric layer 102 faces the radar antenna 105. The radar antenna transmits the electric radiation in the vertical direction.

The electric device 100 may comprise an optoelectronic semiconductor device 101. For example, the optoelectronic semiconductor device 101 may be implemented as an LED (“light emitting diode”) or as a photo detector. As is clearly to be understood, the electric device may comprise any other kind of semiconductor device. Further, the optoelectronic semiconductor device may be implemented as any other kind of optoelectronic device. FIG. 1A further shows an example of a structure of the optoelectronic semiconductor device. The optoelectronic semiconductor device 101 may comprise a first semiconductor layer 110 of a first conductivity type, e.g. p-type, a second semiconductor layer 112 of a second conductivity type, e.g. n-type and an active zone 113 for generating or absorbing electromagnetic radiation. The active zone 113 is arranged between the first semiconductor layer 110 and the second semiconductor layer 112. A detailed description hereof is omitted. The single optoelectronic semiconductor devices may be mounted over a second main surface 126 of the dielectric layer 102. The second main surface 126 is on a side remote from the radar antenna 105. According to further implementations, the optoelectronic semiconductor devices 101 may be embedded in the dielectric layer 102. For example, a horizontal dimension s of the single optoelectronic semiconductor device 101 may be less than 1 mm, e.g. less than 200 μm or less than 30 μm.

The metal wiring 108 may be implemented as a mesh as indicated in the right-hand portion of FIG. 1A. The metal wiring 108 may be configured to electrically connect the optoelectronic semiconductor device 101. By way of example, the first or the second semiconductor layer 101, 102 may be electrically connected to the metal wiring 108. For example, the first or the second semiconductor layer 101, 102 may be connected to a corresponding terminal via the metal wiring 108. In more detail, the first semiconductor layer 101 may be electrically connected to a first terminal, e.g. via a first part of the metal wiring 108. Further, the second semiconductor layer 102 may be electrically connected to a second terminal, e.g. via a second part of the metal wiring 108.

For example, the mesh 109 may be provided so as to introduce redundancy in case any of the components of the mesh 109 fails. FIG. 1A shows several optoelectronic semiconductor devices 101 that may e.g. be connected in series and/or in parallel. According to implementations, in this way, e.g. a segmented LED illumination can be realized. For example a certain amount of serial and/or parallel connected optoelectronic semiconductor devices 101 may be controlled together and form a segment. Several of such individually controlled segments may form an illumination unit.

For example, the electric device 100 may be implemented as an illumination foil. For example, a thickness d of the dielectric layer (stack) 102 may be larger than 100 μm. For example, the thickness of the dielectric layer (stack) 102 may be less than 10 mm or less than 5 mm. For example, the thickness d of the dielectric layer (stack) 102 may be in a mm range. When the dielectric layer 102 is implemented as a dielectric layer stack comprising a plurality of dielectric sublayers, a thickness of the dielectric sublayers may be also smaller than 10 μm, e.g. smaller than 1 μm.

A thickness t of the metal wiring 109 may be 30 nm to 100 μm, for example, 0.2 μm to 10 μm, or e.g. 1 to 3 μm.

FIG. 1B further shows dimensions of the mesh 109. A period p, i.e. a distance between adjacent wires may be less than a wavelength emitted by the radar antenna. For example, the period p may be less than 1 mm, e.g. less than 500 μm. According to further examples, the period p may be less than 250 μm e.g. less than 200 μm or even less than 150 μm. A width w of the single wires may be less than 100 μm, e.g. less than 30 μm or less than 25 μm. The width w of the single wires may be larger than 1 μm or larger than 8 μm.

FIG. 2A illustrates a cross-sectional view of the dielectric layer 102 including standing waves 124 of the electromagnetic radiation that may be formed in the dielectric layer 102. The view of FIG. 2A is tilted with respect to the view of FIG. 1A. As is shown, when electromagnetic radiation 15 is incident to the dielectric layer 102, at least one standing wave 124 having at least one minimum of electric field intensity within the dielectric layer 102 may be generated, when the radiation is reflected at the interface between the dielectric layer 102 and the surrounding medium, e.g. air. FIG. 2A further shows output electromagnetic radiation 16. The thickness d of the dielectric layer 102 may e.g. be determined so that d=λ*m/(n*2).

Accordingly, a cavity mode formed in the dielectric layer 102 is resonant to incident electromagnetic radiation 15. The lower portion of FIG. 2A shows the electric field strength 120 in dependence from the position within the dielectric layer 102. As is shown, the electric field strength 120 oscillates so as to have an electric field strength minimum 121 at a position of a minimum of the standing wave 124. The electric field strength 120 further has an electric field strength maximum 122 at a position of the standing waves 124 being at a maximum amplitude.

FIG. 2A further illustrates examples of positions of the metal wiring 108. When the metal wiring 108 is arranged at the electric field strength maximum position 118, the metal wiring is at the position of the highest electric field strength. Accordingly, a highest amount of absorption or reflection occurs due to maximum coupling strength to the cavity mode field. When the metal layer 108 is arranged at a electric field minimum position 119, its position corresponds to the position of the lowest electric field. As a consequence, a lowest degree of absorption or reflection occurs due to a minimum field strength of the cavity mode.

FIG. 2A further shows the cavity field modulation 123 which represents the difference between a maximum and a minimum of the electric field strength. The cavity field modulation depends on the Q factor of the cavity. The cavity field modulation may be increased by increasing the reflectivity at the surfaces of the dielectric layer 102. As is shown in FIG. 2A since a thickness of the dielectric (multi)layer (stack) 102 is selected to that a standing electromagnetic wave 124 may be generated, it is possible to place the metal wiring 108 at positions in which a coupling of the standing electromagnetic wave to the metal wiring 108 may be reduced to a minimum. As a result, optimized transmission of the electromagnetic radiation may be achieved.

FIG. 2B shows a chart of a simulated transmission spectrum of electromagnetic waves in dependence from the wavelength. The simulated spectrum is based on the use of a single dielectric layer having a thickness of 975 μm and a refractive index of 2. The simulation has been made under the assumption of a plane-wave incidence and that the device is in the far-field of the radar antenna, meaning the distance between the wiring and the antenna is larger than a multiple of the wavelength of the emitted radiation.

However, a device in which the distance between the wiring and the antenna is smaller than e.g. a wavelength of the emitted radiation also shows the described effects.

The insert on the upper left side shows the dielectric layer 102 including the incident electromagnetic radiation 15 and the output electromagnetic radiation 16. As is shown in the chart, a maximum of transmission T may e.g. be at a wavelength of λ=4 mm and at a wavelength of λ=2 mm. The diagram of FIG. 2B further shows two wavelengths λ₁ and λ₂ which correspond to usually used wavelengths for radar measurements. The insert on the upper right side of FIG. 2B shows the electric field intensity for a wavelength of 2 mm (on the left side) and for a wavelength of 4 mm (right side). As is shown for λ=2 mm on the left side, there is a maximum of the field intensity in the center of the dielectric layer 102. Between the center and an edge portion (first or second main surface) of the dielectric layer, the electric field intensity falls to a minimum. Further, as is shown in the right diagram on the right side, for a wavelength of 4 mm, there is a minimum of the field intensity in the center of the dielectric layer 102 and the intensity increases to the edge portion.

FIG. 2C illustrates the simulated transmission of electromagnetic waves when the metal wiring 108 is arranged at different positions of the dielectric layer 102. For example, a period of the metal mesh in this simulation is 200 μm. The left-hand portion shows the dielectric layer 102 including the metal wiring 108, which may be implemented as a mesh 109. The left-hand portion of FIG. 2C further illustrates incident electromagnetic radiation 15 and output electromagnetic radiation 16. As is indicated by the arrow on the left side, the vertical position of the metal wiring 108 may be varied.

As is shown in the insert on the right side of the diagram, a position of the metal wiring 108 in the center of the dielectric layer 102 is represented by chart 3 (solid line). A position of the metal wiring 108 on the second main surface 126 of the dielectric layer 102 is represented by chart 1 (dotted line) and a position of the metal wiring 108 between the center and the second main surface 126 is represented by chart 2 (broken line). Chart 0 represents a dielectric layer without a mesh and chart ∞ represents a dielectric layer having an infinite thickness and which further includes a metal layer. The diagram of FIG. 2C further shows positions of two generally used radar wavelengths, e.g. λ₁ of 3.9 mm and λ₂ of 12.4 mm.

As can be taken from the diagram, at a wavelength λ₁ of 3.9 mm, which corresponds to a typical radar wavelength, when the metal wiring 108 is placed in the center position, the transmission is much higher than in a case when the metal wiring 108 is placed at the second main surface 126 of the dielectric layer 102 (chart 1) or in a position between the center position and the second main surface 126 of the dielectric layer 102 (chart 2) or compared to chart “∞” where no cavity mode builds up within the dielectric layer. At a wavelength of λ₁, chart 3 shows approximately an enhancement of the signal of a factor of more than 4 when assuming a multiple transmission through the dielectric layer.

The label 2b considers the charts at a wavelength of approximately 2 mm where a strong enhancement of the transmission is achieved when the metal wiring is at a position (2) between center position (3) and the position (2) at the second main surface 126 of the dielectric layer 102. In this case, the electric field intensity within the dielectric layer 102 varies as shown in the left upper inset of FIG. 2B. Thus, the vertical position (2) is located at a minimum of the field intensity within the layer for 2 mm wavelength.

For different intended wavelengths, an analogous enhancement can be achieved by the described principles.

FIGS. 3A and 3B show further implementations of the dielectric layer 102 according to embodiments. For example, as is illustrated in FIG. 3A, the dielectric layer 102 may comprise a first dielectric layer 103 and a second dielectric layer 104. The first dielectric layer 103 may be arranged on one side of the metal wiring 108. The second dielectric layer 104 may be arranged on a second side of the metal wiring 108.

According to the implementation shown in FIG. 3B, the first dielectric layer 103 and/or the second dielectric layer 104 may each comprise a multilayer stack. In other words, the first dielectric layer 103 may comprise a first multilayer stack 116. Further or alternatively, the second dielectric layer 104 may comprise a second multilayer stack 117. In this way, it is possible to enhance the cavity effect.

FIG. 4A shows an example of an emission device 11 or an electronic system 10. As is shown, the dielectric layer 102 comprising the metal wiring 108 may be directly placed over the radar antenna 105. In this case, the distance between the metal wiring 108 and the radar antenna 105 may be in a subwavelength range. Accordingly, the metal wiring 108 is arranged in the near-field of the antenna. Also in this case, an optimized position of the metal wiring 108 may be determined in the manner as has been described above.

According to further embodiments, instead of a metal wiring 108, a thin metal layer 107 may be arranged in the dielectric layer (stack) 102. As is shown in FIG. 4, an emission device 11 comprises a radar antenna 105 which is configured to emit electromagnetic radiation having a wavelength λ and the dielectric layer 102 which is arranged in an emission direction of the radar antenna. The emission device further comprises a metal layer 107 having a thickness of less than 150 nm. A thickness d of the dielectric layer 102 measured in a vertical direction is determined so that at least one standing wave is generated in the dielectric layer having at least one minimum of electric field intensity within the dielectric layer 102. For example, d=λ*m/(n*2). In this formula, m denotes an integer and n denotes a refractive index of the dielectric layer 102. The metal layer 107 is arranged in a horizontal layer of the dielectric layer 102. A vertical position v of the metal layer is determined so that it corresponds to a minimum of the electric field strength of electromagnetic radiation having the wavelength λ.

As has been found out, when the thickness of the metal layer is less than the skin depth of the metal layer, e.g. several hundred nm, damping of radar emission is suppressed if the metal layer is placed at a vertical position corresponding to the minimum of the electric field strength of electromagnetic radiation having the wavelength λ.

As has been described above, due to the special arrangement of the metal wiring or the metal layer, it is possible to arrange a conductive layer or a metal wiring over a radar antenna.

Radar transmission through the metallic wiring or metal layer on or in the illumination cover is enhanced, and enables the usage of metallic layers or wirings for the application on radar cover plates.

As a result, the radar module having a compact size and further including an illuminated cover may be implemented. For example, it is possible to integrate the radar module into an automotive frontlight or backlight. Further, the emission and detection path of the radar emission may be functionalized with illumination features such as illuminated logos.

For example, the electronic system 10 may lead to a combination of a radar module with a segmented LED illumination unit which is arranged on or in a foil.

FIG. 4B shows an example of an electronic system 10 as has been discussed above. The radar antenna 105 is configured to emit electromagnetic radiation. The electromagnetic radiation is reflected by an object 23 to form reflected electromagnetic radiation 21. Further, the electric device may be implemented as an LED which further emits light 22 towards the object.

For example, the electronic system may be an automotive back light.

According to further examples, the optoelectronic semiconductor device may be implemented as a sensor.

As is to be clearly understood, the concepts described may as well be applied to an arbitrary emission device comprising a radar antenna, a dielectric layer and a metal layer. Further, the electronic system 10 may comprise an arbitrary electric device.

While embodiments of the invention have been described above, it is obvious that further embodiments may be implemented. For example, further embodiments may comprise any subcombination of features recited in the claims or any subcombination of elements described in the examples given above. Accordingly, this spirit and scope of the appended claims should not be limited to the description of the embodiments contained herein.

### LIST OF REFERENCES

10 electronic system
11 emission device
15 incident electromagnetic radiation
16 output electromagnetic radiation
20 emitted electromagnetic radiation
21 reflected electromagnetic radiation
22 emitted light
23 object
100 electric device
101 optoelectronic semiconductor device
102 dielectric layer
103 first dielectric layer
104 second dielectric layer
105 radar antenna
106 wire
107 metal layer
108 metal wiring
109 grid
110 first semiconductor layer
112 second semiconductor layer
114 active zone
116 first multilayer stack
117 second multilayer stack
118 electric field maximum position
119 electric field minimum position
120 electric field strength
121 electric field strength minimum
122 electric field strength maximum
123 cavity field modulation
124 standing wave
125 first main surface
126 second main surface

1. An electronic system comprising:
a radar antenna, configured to emit electromagnetic radiation having a wavelength λ in a first direction, and
an electric device, the electric device being arranged in an emission direction of the radar antenna, the electric device comprising a dielectric layer and a metal wiring for contacting elements of the electric device, wherein
a thickness of the dielectric layer measured in the first direction is determined so that the emitted electromagnetic radiation forms at least one standing wave having at least one minimum of electric field intensity within the dielectric layer,
the metal wiring is arranged in a horizontal layer of the dielectric layer, and
a position, in the first direction, of the metal wiring is determined so that it corresponds to a minimum of the electric field strength of electromagnetic radiation having the wavelength λ.

2. The electronic system according to claim 1, wherein the thickness d of the dielectric layer is determined so that
$$d = λ * m / ( n * 2 ) ,$$
wherein m denotes an integer with m>0, and n denotes a refractive index of the dielectric layer.

3. The electronic system according to claim 1, wherein the metal wiring comprises a metal mesh.

4. The electronic system according to claim 3, wherein the metal mesh has a thickness of 0.2 μm to 10 μm.

5. The electronic system according to claim 3, wherein a width of the individual metal wires forming the metal mesh is 8 to 25 μm.

6. The electronic system according to claim 3, wherein a period of the metal mesh is smaller than λ/n.

7. The electronic system according to claim 3, wherein a period of the metal mesh is larger than 0.1*λ/n.

8. The electronic system according to claim 1, wherein the electric device comprises an optoelectronic semiconductor device, the optoelectronic semiconductor device comprising:
a first semiconductor layer of a first conductivity type;
a second semiconductor layer of a second conductivity type, and
and active zone for generating or absorbing electromagnetic radiation, the active zone being arranged between the first semiconductor layer and the second semiconductor layer.

9. The electronic system according to claim 8, wherein the metal mesh is electrically connected to the first or the second semiconductor layer.

10. The electronic system according to claim 1, wherein the dielectric layer comprises a first dielectric layer and a second dielectric layer, and the metal layer is arranged between the first dielectric layer and the second dielectric layer.

11. The electronic system according to claim 10, wherein at least one of the first and the second dielectric layers comprises a multilayer stack.

12. The electronic system according to claim 2, wherein the position v, in the first direction, of the metal wiring is determined as
$$v = λ * ( k + 0.5 ) / ( 2 * n ) , wherein k < m .$$

13. An emission device, comprising:
a radar antenna, configured to emit electromagnetic radiation having a wavelength λ in a first direction,
a dielectric layer being arranged in an emission direction of the radar antenna, and
a metal layer having a thickness of less than 500 nm, wherein
a thickness d of the dielectric layer measured in the first direction is determined so that the emitted electromagnetic radiation forms at least one standing wave having at least one minimum of electric field intensity within the dielectric layer,
the metal layer is arranged in a horizontal layer of the dielectric layer, and
a position, in the first direction, of the metal layer is determined so that it corresponds to a minimum of the electric field strength of electromagnetic radiation having the wavelength λ.

14. The emission device according to claim 13, wherein the thickness d of the dielectric layer is determined so that
$$d = λ * m / ( n * 2 ) ,$$
wherein m denotes an integer larger than 0 and n denotes a refractive index of the dielectric layer.

15. The emission device according to claim 14, wherein the position v, in the first direction, of the metal layer is determined as
$$v = λ * ( k + 0.5 ) / ( 2 * n ) , wherein k < m .$$
